(19) United States
(12) Patent Application Publication
(10) Pub. No.: US 2026/0321840 A1
(43) Pub. Date: Oct. 15, 2026

(54) MULTI-STAGE PRESSURE SOLID-STATE BATTERY MODULE

(71) Applicant: Schaeffler Technologies AG & Co. KG, Herzogenaurach (DE)

(72) Inventors: Rashid Farahati, Copley, OH (US); Paul Lindemann, Howard, OH (US); Louis McGrath, Strasburg, OH (US)

(73) Assignee: Schaeffler Technologies AG & Co. KG, Herzogenaurach (DE)

(21) Appl. No.: 19/465,453

(22) Filed: Jan. 30, 2026

Related U.S. Application Data
(60) Provisional application No. 63/756,760, filed on Feb. 10, 2025.

(51) Int. Cl. H01M 50/242; H01M 50/209; H01M 50/293

(52) U.S. Cl. CPC H01M 50/242; H01M 50/209; H01M 50/293

(57) ABSTRACT

A battery assembly including first and second end plate and a plurality of battery cells stacked between the first and second end plates. At least one first compression spring has a first spring travel distance, at least one second compression spring has a second spring travel distance that is less than the first spring travel distance, and at least one travel end stop is disposed proximate to the at least first compression spring and the at least second compression spring. A tension belt system is wrapped around the first and second end plates to provide stacked compression between the first and second end plates.

### CROSS-REFERENCE TO RELATED APPLICATIONS

This application claims priority under 35 U.S.C. § 119(e) and the benefit of U.S. Provisional Patent Application No. 63/756,760, entitled MULTI-STAGE PRESSURE ALL SOLID-STATE BATTERY MODULE DESIGN, filed on Feb. 10, 2025, which is incorporated herein by reference in its entirety.

### FIELD OF THE DISCLOSURE

The present disclosure generally relates to a solid-state battery, and more particularly relates to a multi-stage pressure all solid-state battery (ASSB) module design.

### BACKGROUND OF THE DISCLOSURE

All-solid-state batteries (ASSB) are becoming a promising solution to address the limitations of traditional lithium-ion batteries. ASSBs include solid materials that replace the use of liquid electrolyte used in lithium-ion batteries. ASSBs provide enhanced safety, increase energy density, and extend the overall lifespan of energy storage systems. Additionally, ASSBs store more energy stored in the same amount of space, making them convenient for applications having limited space for energy storage, such as electric vehicle and portable electronics.

### SUMMARY OF THE DISCLOSURE

According to a first aspect of the present disclosure, a battery assembly has first and second end plates and a plurality of battery cells stacked between the first and second end plates. At least one first compression spring has a first spring travel distance, and at least one second compression spring has a second spring travel distance that is less than the first spring travel distance. At least one travel end stop is disposed proximate to the at least first compression spring and the at least second compression spring. A tension belt system is wrapped around the first and second end plates to provide stacked compression between the first and second end plates.

Embodiments of the first aspect of the disclosure can include any one or a combination of the following features:
a movable pressure plate wherein the at least one first compression spring and at least one second compression spring are disposed between the movable pressure plate and the second end plate;
the movable pressure plate includes one or more first spring holders, and the second end plate includes one or more second spring holders;
the at least one first compression spring and the at least one second compression spring are extended within the one or more first spring holders and the one or more second spring holders;
the at least one first compression spring incudes a plurality of first compression springs, and the at least one second compression spring includes a plurality of second compression springs;
the first and second springs are nested such that the second compression spring is within an inner space of the first compression spring;
the first and second springs are nested such that the second compression spring is within an inner space of the first compression spring;
the at least one travel end stop is integrated on one of the movable pressure plate and second end plate;
the outer surfaces of first and second end plates are curved;
each of the first and second end plates have slots extending in the outer surface;
the tension belt system comprises a plurality of straps that extend within the slots on the first and second end plates;
compliant material is slotted between each of the plurality of battery cells;
the compliant material includes polyurethane or rubber; and
each of the plurality of battery cells comprises a solid-state battery cell.

According to a second aspect of the present disclosure, a battery assembly has first and second end plates and a plurality of solid-state battery cells stacked between the first and second end plates, a plurality of first compression springs, each having a first spring travel distance, a plurality of second compression springs, each having a second spring travel distance that is less than the first spring travel distance and a movable pressure plate. At least one travel end stop is disposed proximate to the at least first compression spring and the at least second compression spring. The first plurality of compression springs and the second plurality of compression springs are disposed between the movable pressure plate and the second end plate. A tension belt system having a plurality of straps is wrapped around the first and second end plates to provide stacked compression between the first and second end plates.

Embodiments of the second aspect of the disclosure can include any one or a combination of the following features:
the movable pressure plate includes one or more first spring holders, and the second end plate includes one or more second spring holders;
the at least one first compression spring and the at least one second compression spring are extended within the one or more first spring holders and the one or more second spring holders;
the at least one first compression spring incudes a plurality of first compression springs, and the at least one second compression spring includes a plurality of second compression springs;
the first and second springs are nested such that the second compression spring is within an inner space of the first compression spring;
the outer surfaces of first and second end plates are curved;
each of the first and second end plates have slots extending in the outer surface;
compliant material is slotted between each battery cell; and
the compliant material includes polyurethane or rubber.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic diagram of a battery powered device having a multi-stage solid-state battery assembly, according to one example;

FIG. 2 is a perspective view of the solid-state battery assembly having a plurality of battery cells stacked in a module, according to one example;

FIG. 2A is a perspective view of the solid-state battery assembly shown in FIG. 2 with the cover removed;

FIG. 3 is a cross-sectional view of the solid-state battery assembly taken through lines III-III of FIG. 2A with a low battery state of charge of about 0%;

FIG. 4 is a cross-sectional view of the solid-state battery assembly taken through lines IV-IV of FIG. 2A; and

FIG. 5A is a cross-sectional view of the solid-state battery assembly taken through a lower portion of FIG. 4 showing the battery assembly discharged at a low state of charge of about 0%;

FIG. 5B is a cross-sectional view of the battery assembly taken through a lower portion of FIG. 4 showing the solid-state battery assembly partially charged at a mid-state of charge of about 50%;

FIG. 5B is a cross-sectional view of the battery assembly taken through a lower portion of FIG. 4 showing the solid-state battery assembly at a high or full state of charge of about 100%;

FIG. 6 is an exploded perspective view of the solid-state battery assembly; and

FIG. 7 is a graph illustrating the compression of the primary and secondary springs when subjected to different pressure stages depending on the state of charge of the battery assembly.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis of a shaft configured to rotate in operation of the apparatus described herein. Further, the term “radial” and derivatives thereof, such as “radially,” shall be understood in relation to the axis of the aforementioned shaft. For example, “radially outboard” refers to further away from the axis, while “radially inboard” refers to nearer to the axis. The term “circumferential” and derivatives thereof, such as “circumferentially,” shall be understood in relation to the axis of the aforementioned shaft.

Solid-State Battery Cells require a stack pressure during cycling (charge/discharge) to prevent degradation by ensuring good interfacial contact between cell component layers. This will need to be considered during the design of solid-state battery packs, for example, in electric vehicle (EV) applications which require compact design. The battery assembly shown and described in this disclosure takes advantage of energy density improvements that solid-state battery cells offer over traditional Liquid Lithium-Ion batteries. Further considerations include the envelope and weight of the compression mechanism.

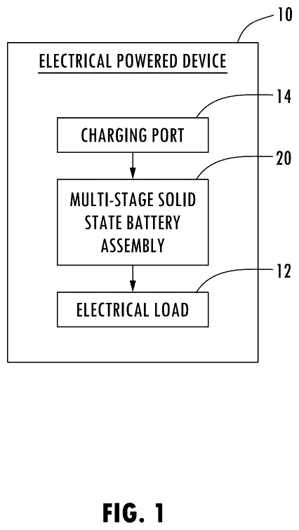

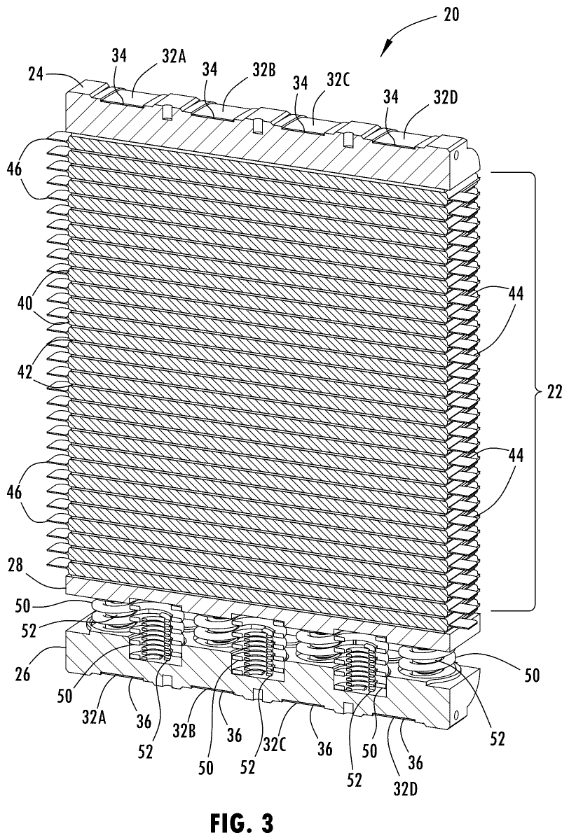

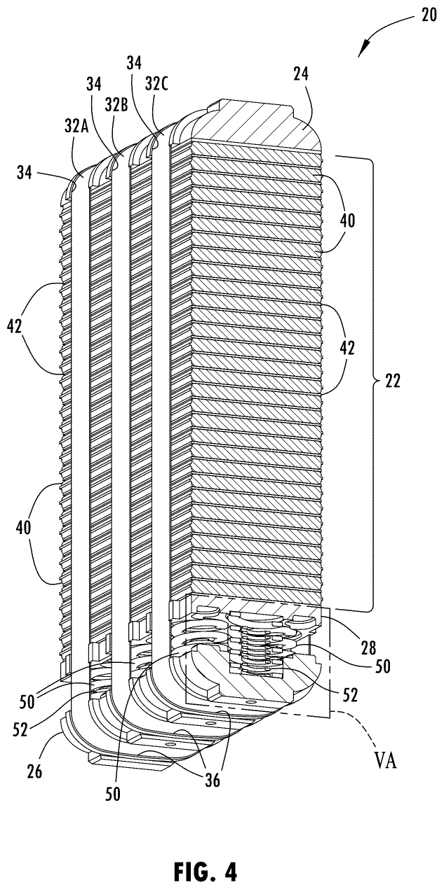

As shown in FIG. 1-7, a solid-state battery assembly 20 is shown having multiple-compression springs between first and second end plates and a tension belt system that enhances the overall energy density of the exemplary all solid-state battery (ASSB) module. The battery assembly 20 comprises first and second end plates with a plurality of battery cells stacked between the first and second end plates. At least one first compression spring has a first spring travel distance, and at least one second compression spring has a second spring travel distance that is less than the first spring travel distance. At least one travel end stop is disposed proximate to the at least first compression spring and the at least second compression spring. A tension belt system is wrapped around the first and second end plates to provide stacked compression between the first and second end plates.

A key feature of this design is the incorporation of the first and second end plates, also referred to as end caps, and the tension belt system which transfer pressure during the final stage of operation. This pressure exceeds what the spring material can handle alone. Using end plates for the application allows more pressure than the spring arrangement permits, allowing for increased flexibility and efficiency in the operation of the battery assembly. The end plates are capable of withstanding and managing higher pressures, improving the system's overall performance and durability. Additionally, the pressure at different states of charge may be optimized to achieve better performance.

As shown, the design allows for a smaller gap for the spring, resulting in higher energy density. This is beneficial because it allows more efficient use of space and materials, leading to a more compact and robust system.

The battery assembly produces varying pressures in different states of charge (SOC). The design effectively manages this variability, ensuring optimal performance across a range of state-of-charge SOC. A key feature of this design is the use of end plates, which transfer the last-stage pressure. This pressure is higher than what the spring material alone can handle. By incorporating the end plates and the tension belt system, pressure can be applied beyond the spring's capacity, thus not being limited by the spring design. This allows for greater flexibility and efficiency in the overall operation, as the end plates can withstand and manage higher pressures, enhancing the overall performance and durability of the solid-state battery assembly 20.

Referring to FIG. 1, an electrical powered device 10 is generally illustrated having a multi-stage solid-state battery assembly 20, also referred to as an all solid-state battery (ASSB) assembly. The electrical powered device 10 may include an electric vehicle, such as a battery-powered electric vehicle or a hybrid vehicle, for example, employing one or more multi-stage solid-state batteries 20 to power one or more electrical loads, such as one or more electric motors. For a vehicle application, the battery assembly 20 may output a high voltage such as 400 volts or 800 volts, for example. The electrical powered device 10 may otherwise be configured as a portable electronic device or a humanoid, such as a robot, for example. The solid-state battery assembly 20 is a rechargeable solid-state battery assembly that may be charged using a charging port 14 that receives and supplies electricity with a charging voltage to charge the solid-state battery assembly 20.

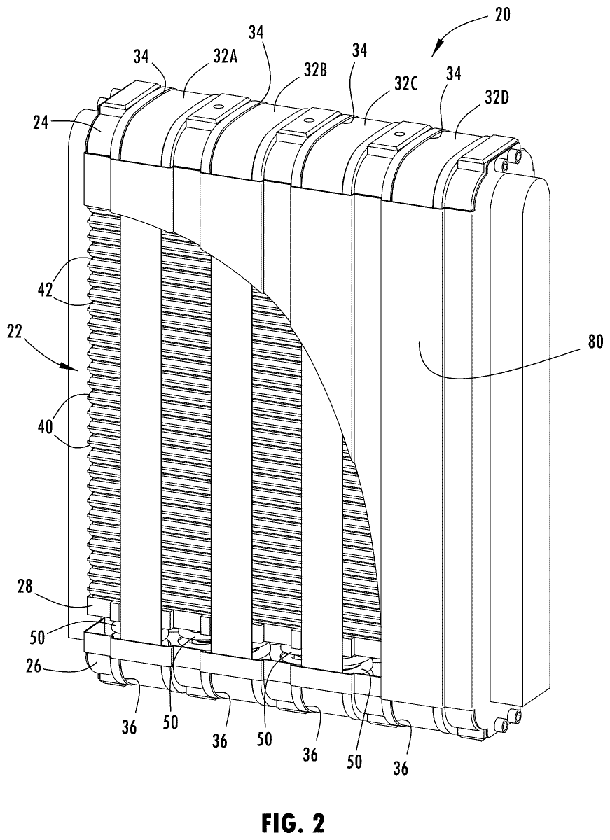

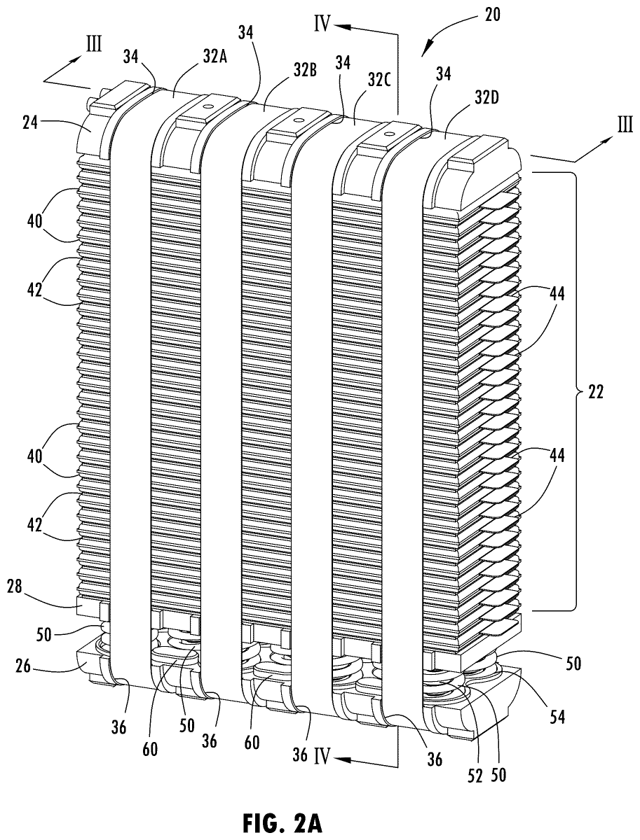

The solid-state battery assembly 20 is shown in FIGS. 2-4, according to one embodiment. The battery assembly 20 is a multi-stage pressure all solid-state battery assembly packaged as a module and having a plurality of solid-state battery cells 40 stacked one on top another in a stacked arrangement. The battery assembly 20 has an outer cover 80 that covers at least a portion of the battery cells 40 and extends between opposite ends where it may be connected with fasteners. The battery cells 40 are solid-state battery cells and may include two or more solid-state battery cells. The battery cells 40 generally include an anode and a cathode and are configured in one example having a length and width defining a rectangular shape and a relatively thin thickness. The battery cells 40 include positive and negative contact terminals 44, 46 shown located on opposite ends. The solid-state battery cells 40 generally expand and contract in thickness during charging and discharging cycles which is the result of ions moving within the electrode material. For example, lithium ions may move from the cathode to the anode during charging, thereby causing the anode material to expand. During discharging the reverse happens and the anode contracts.

To accommodate the changes in expansion and contraction of the battery cells 40, the solid-state battery assembly 20 is configured with first and second end plates 24 and 26 shown on opposite ends of the battery stack and having first and second compression springs of different sizes positioned between the first and second end plates 24 and 26 in series with the battery cells 40 to create multiple pressure zones. The first and second end plates 24 and 26 are fixed and generally rectangular with a size similar to the length and width of the battery cells 40 and have rounded outer surfaces. The first and second end plates 24 and 26 may be formed of metal, for example. The first end plate 24 extends over one end of the battery cells. The first end plate 24 includes a rounded outer surface with a plurality of first slots 34 for receiving a corresponding number of straps 32A-32D. The second end plate 26 extends over the opposite end of the stack of battery cells 40 and likewise has a rounded outer surface with a plurality of second slots 36 for receiving the straps 32A-32D. The first and second slots 34 and 36 are configured to receive the plurality of straps 32A-32D as part of a tension belt system that wraps around both end plates 24 and 26 and the stack of battery cells 40 over both ends of the first and second end plates 24 and 26.

The plurality of battery cells 40 are generally stacked one on top another with a compliant material layer 42 disposed between adjacent battery cells 40. A compliant material layer 42 may also be located between the upper surface of the top most battery cell 40 and the lower surface of the first end plate 24. The compliant material may include a thin sheet or mat made of polyurethane or rubber, for example. A moving plate 28 is disposed at the bottom end of the battery stack and provides an upper support for the plurality of first and second compression springs which are biased between the moving plate 28 and the fixed second end plate 26 to apply a pressure to the stack of battery cells 40. The moving plate 28 is generally rectangular and may be made of metal.

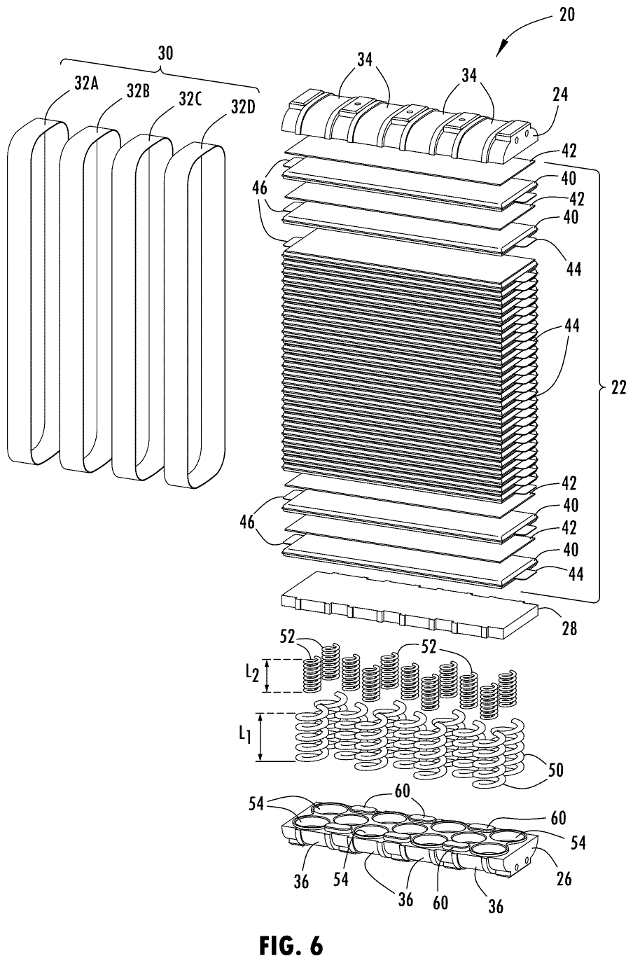

The moving plate 28 is shown having a lower surface opposite the upper side which faces the stack of battery cells 40. The lower surface is configured with cylindrical recesses 64 for receiving the upper end of the first and second compression springs and further with recesses 62 for receiving an end stop 60 on the upper surface of the second end plate 26 when the battery assembly 20 and the first and second compression springs are fully compressed when the battery assembly 20 is substantially charged such as at or near a full 100% state of charge. The upper surface of the second end plate 26 has a plurality of cylindrical recesses 54 which are aligned with recesses 64 to receive first and second compression springs 50 and 52. As seen in FIG. 6, the upper surface of the second end plate 26 further includes a plurality of end stops 60 which are integrally formed thereon, in one example.

The solid-state battery assembly 20 includes at least one first compression spring 50 having a first length L₁ with a first spring travel distance. The first compression spring 50 may also be referred to as a primary compression spring. In the example shown, a plurality of first compression springs 50 are illustrated configured as coil springs, each configured to fit within cylindrical recesses 54 and 64. The battery assembly 20 also includes at least one second compression spring 52 having a second length L₂ with a second spring travel distance that is less than the first spring travel distance. The at least one second compression spring 52, which is shown as a coil spring, is also referred to as a secondary spring. A plurality of second compression springs 52 are shown in this example. The second compression springs 52 are coaxially aligned with separate ones of the first compression springs 50 such that each second compression spring 52 fits within the interior space of a first compression spring 50, with both co-axially aligned within the cylindrical recesses 54 and 64. As such, cylindrical recesses 54 and 64 retain the first and second compression springs 50 and 52 in place between the first and second end plates 26, and the moving plate 28 and the first and second compression springs 50 and 52 compress with force by a distance depending upon the expansion and contraction of the battery cells 40 which changes depending on the state of charge of the battery cells 40. The first compression springs 50 provide a first spring constant which, when compressed alone, provides a first stage pressure. The first and second compression springs 50 and 52 provide a second higher spring constant which provides a higher second stage pressure when compressed at the same time.

The battery assembly 20 includes a tension belt system 30 which employs one or more straps wrapped around the first and second end plates 24 and 26 and under tension to provide a stacked compression force between the first and second end plates 24 and 26. In the example shown, the tension belt system 30 includes four straps 32A-32D spaced apart along a width of the battery assembly 20. The straps 32A-32D may be metal straps that are assembled onto the outer surface of the battery assembly 20 to fit within slots 34 and 36 in the outer rounded ends of the first and second end plates 24 and 26, respectively. The straps 32 are applied onto the assembled module under tension and serve as tension belts to maintain a compressed state of the solid-state battery assembly 20 with a compression force or pressure between the moveable moving plate 28 and the first end plate 24 which results in the pressure applied to the stack of battery cells 40.

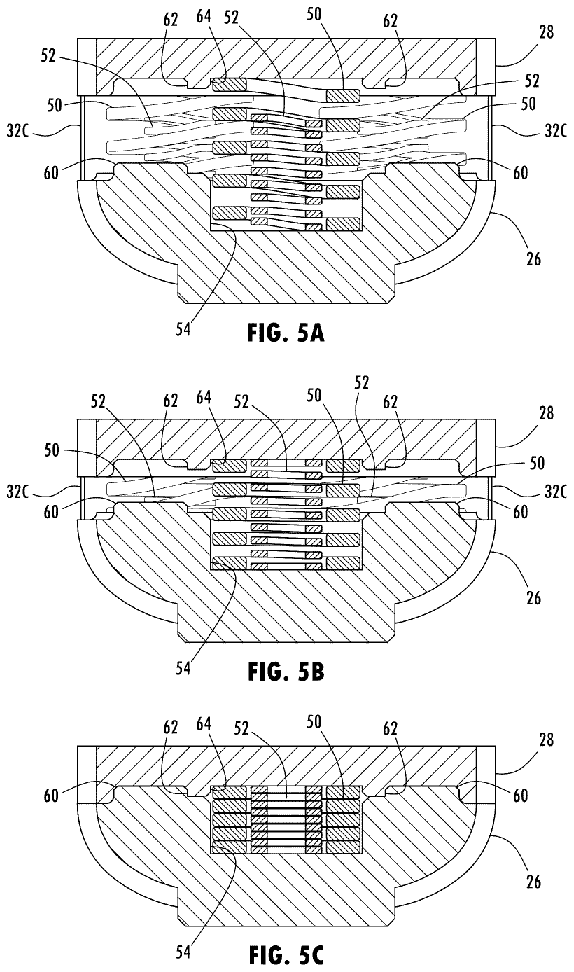

The reconfiguration of the battery assembly 20 during expansion and contraction of the battery cells 40 is illustrated in FIGS. 5A-5C. As seen in FIG. 5A, the battery assembly 20 has the least amount of spring compression such as when the battery assembly has a low state of charge such as about 0%. In this configuration, the tension belt system applies a force with a stationary or baseline first stage pressure. The longer length first or primary compression springs 50 are shown compressed between the moving plate 28 and the fixed second end plate 26. The shorter length secondary compression springs 52 are not engaged with the moving plate 28 and thus are not compressed. This results in the first stage pressure applied by the primary compression springs 50.

As the state of charge of the battery assembly 20 increases, the battery cells 40 expand in thickness resulting in enhanced force and pressure that moves the moving plate 28 downward towards the second end plate 26 to thereby linearly compress the primary or first compression springs 50. Once the battery assembly 20 reaches a mid-state of charge such as a 50% state of charge, the moving plate 28 further contacts the secondary or second compression springs 52, thus resulting in a second stage pressure with both primary compression springs 50 and secondary compression springs 52 applying a bias force against the moving plate 28 and being compressed.

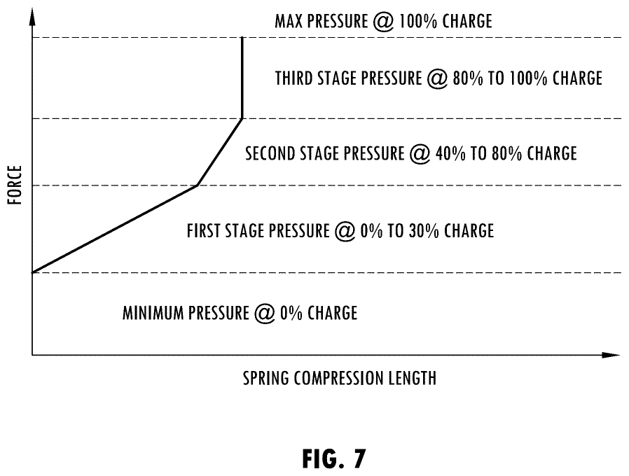

In the second stage of expansion, the moving plate 28 continues to move downward towards the second end plate 26 as the battery cells 40 are further charged, and the battery cells 40 further expand at the second stage pressure which is illustrated in FIG. 7 for an exemplary state of charge of 40% to 80%, for example. As the battery assembly 20 continues to expand during further charging, the moving plate 28 moves downward to fully compress the first and second compression springs 50 and 52 until end of travel stops 60 contact the end limits of recesses 62 to thereby prevent further movement of the moving plate 28 towards the second end plate 26. At this point, further movement of the moving plate 28 is prevented, and the third stage pressure is realized with a battery state of charge of about 80% to 100% state of charge, according to one example. The battery assembly 20 may be further charged until it reaches 100% state of charge.

The solid-state battery assembly 20 advantageously provides for a compact solid-state module design with a stacked battery cell arrangement that is expandable independent of application force and provides a pressure to ensure contact between the stacked layers by employing first and second end plates 24 and 26 and a tension belt system 30. The tension belt system 30 includes straps 32 that offer a lightweight and optimized solution for the clamping force. The curved end plates provide a minimal bending stress that is applied to the battery cells 40 during compression to ensure a uniform pressure distribution. The nested arrangement of the first and second compression springs 50 and 52 allows for a passive control of the stacked pressure that may be tuned to a desired application. The battery assembly 20 is advantageously beneficial for use on various powered devices such as an electric vehicle.

A number of implementations have been shown and described herein. Nevertheless, it will be understood that various modifications may be made without departing from the spirit and scope of the disclosure. Accordingly, other implementations are within the scope of the following claims.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 electrical powered device
14 charging port
20 battery assembly
24 first end plate
26 second end plate
28 moving plate
30 tension belt system
32 straps
32A strap
32B strap
32C strap
32D strap
34 first slots
36 second slots
40 battery cells
42 compliant material layer
44 positive contact terminals
46 negative contact terminals
50 first compression spring
52 second compression spring
54 recesses
60 end stop
62 recesses
64 recesses
80 outer cover

What is claimed is:

1. A battery assembly comprising:
first and second end plates;
a plurality of battery cells stacked between the first and second end plates;
at least one first compression spring having a first spring travel distance;
at least one second compression spring having a second spring travel distance that is less than the first spring travel distance;
at least one travel end stop disposed proximate to the at least first compression spring and the at least second compression spring; and
a tension belt system wrapped around the first and second end plates to provide stacked compression between the first and second end plates.

2. The battery assembly of claim 1, further comprising a movable pressure plate, wherein the at least one first compression spring and at least one second compression spring are disposed between the movable pressure plate and the second end plate.

3. The battery assembly of claim 2, wherein the movable pressure plate includes one or more first spring holders, and the second end plate includes one or more second spring holders, wherein the at least one first compression spring and the at least one second compression spring are extended within the one or more first spring holders and the one or more second spring holders.

4. The battery assembly of claim 3, wherein the at least one first compression spring incudes a plurality of first compression springs, and the at least one second compression spring includes a plurality of second compression springs, wherein the first and second springs are nested such that the second compression spring is within an inner space of the first compression spring.

5. The battery assembly of claim 4, wherein the first and second springs are nested such that the second compression spring is within an inner space of the first compression spring.

6. The battery assembly of claim 1, wherein the at least one travel end stop is integrated on one of the movable pressure plate and second end plate.

7. The battery assembly of claim 1, wherein outer surfaces of first and second end plates are curved.

8. The battery assembly of claim 7, wherein each of the first and second end plates have slots extending in the outer surface.

9. The battery assembly of claim 8, wherein the tension belt system comprises a plurality of straps that extend within the slots on the first and second end plates.

10. The battery assembly of claim 1, wherein compliant material is slotted between each of the plurality of battery cells.

11. The battery assembly of claim 10, wherein the compliant material includes polyurethane or rubber.

12. The battery assembly of claim 1, wherein each of the plurality of battery cells comprises a solid-state battery cell.

13. A battery assembly comprising:
first and second end plates;
a plurality of solid-state battery cells stacked between the first and second end plates;
a plurality of first compression springs, each having a first spring travel distance;
a plurality of second compression springs, each having a second spring travel distance that is less than the first spring travel distance;
a movable pressure plate;
at least one travel end stop disposed proximate to the at least first compression spring and the at least second compression spring, wherein the first plurality of compression springs and the second plurality of compression springs are disposed between the movable pressure plate and the second end plate; and
a tension belt system having a plurality of straps wrapped around the first and second end plates to provide stacked compression between the first and second end plates.

14. The battery assembly of claim 13, wherein the movable pressure plate includes one or more first spring holders, and the second end plate includes one or more second spring holders, wherein the at least one first compression spring and the at least one second compression spring are extended within the one or more first spring holders and the one or more second spring holders.

15. The battery assembly of claim 14, wherein the at least one first compression spring incudes a plurality of first compression springs, and the at least one second compression spring includes a plurality of second compression springs.

16. The battery assembly of claim 15, wherein the first and second springs are nested such that the second compression spring is within an inner space of the first compression spring.

17. The battery assembly of claim 13, wherein outer surfaces of first and second end plates are curved.

18. The battery assembly of claim 17, wherein each of the first and second end plates have slots extending in the outer surface.

19. The battery assembly of claim 13, wherein compliant material is slotted between each battery cell.

20. The battery assembly of claim 19, wherein the compliant material includes polyurethane or rubber.
